(19) United States
(12) Patent Application Publication
(10) Pub. No.: US 2020/0249912 A1
(43) Pub. Date: Aug. 6, 2020

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Manabu Ishikawa, Machida-shi (JP); Mohammad Shaik, Kawasaki-shi (JP)

(21) Appl. No.: 16/751,083

(22) Filed: Jan. 23, 2020

(30) Foreign Application Priority Data
Feb. 5, 2019 (JP) 2019-018697

(51) Int. Cl. G06F 7/499; G06F 9/46

(52) U.S. Cl. CPC G06F 7/49947; G06F 9/463

(57) ABSTRACT

A Qround process is executed in a Round process for respective blocks related to the ChaCha algorithm. At that time, in a case where a target round to be operated is a specific round, the execution of the Qround process is skipped. Accordingly, unnecessary process steps are eliminated in execution of the ChaCha algorithm.

### BACKGROUND

### Field

The present disclosure relates to an information processing apparatus, an information processing method, and a storage medium.

### Description of the Related Art

ChaCha, which is a stream cipher, is discussed in D. J. Bernstein, “ChaCha, a variant of Salsa 20”, 2008. The ChaCha algorithm has attracted attention in recent years for its wide use in Transport Layer Security (TLS) (see E. Reactorla, “The Transport Layer Security (TLS) Protocol Version 1.3”, RFC 8446, 2018) and Internet Protocol Security (IPsec), which are each widely used as a protocol for encrypting and securely transmitting data on the Internet.

Communication over the Internet is also widely implemented in embedded devices and Internet-of Things (IoT) devices. In general, these devices are often required to operate at low frequency and with low power consumption. On the other hand, such devices are required to exhibit the processing performance depending on their respective characteristics while maintaining low power consumption. General processing steps are described in Nir, Y. and A. Langley, “ChaCha20 and Poly1305 for IETF Protocols”, RFC 7539, which are implemented in many cryptographic libraries in the same way. However, there is an issue that even though it is possible to remove some steps from the processing steps of the ChaCha algorithm because of the characteristics of the algorithm, the ChaCha algorithm is not optimized, which may affect the performance of the devices operating at low frequency.

### SUMMARY

In the ChaCha algorithm, a plurality of steps for performing an operation is defined even though a fixed initial value is set. Accordingly, the implementation of the algorithm as it is may cause an unnecessary processing step to be executed, which affects the performance.

According to an aspect of the present disclosure, an information processing apparatus that executes a Round process for respective blocks related to the ChaCha algorithm, includes a control unit configured to execute a Qround process in the Round process, and a holding unit configured to hold at least a part of results of the execution of the Qround process. In the information processing apparatus, the control unit is configured to, in a case where a target round to be operated is a specific round, skip the execution of the Qround process by using at least the part of results of the execution of the Qround process held by the holding unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a communication processing integrated circuit.

FIGS. 2A and 2B are flowcharts illustrating an example of an encryption process according to a first exemplary embodiment.

FIG. 3 is a diagram illustrating a plan of a storage unit that stores data used in operations.

FIGS. 4A and 4B are flowcharts illustrating an example of an encryption process according to a second exemplary embodiment.

FIGS. 5A and 5B are flowcharts illustrating an example of an encryption process according to a third exemplary embodiment.

### DESCRIPTION OF THE EMBODIMENTS

Hereinafter, exemplary embodiments of the present disclosure will be described with reference to the drawings.

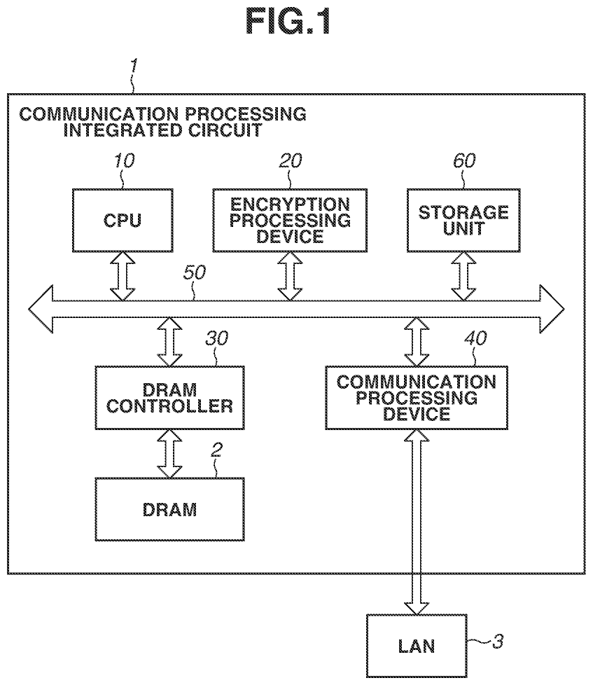

A first exemplary embodiment will now be described. FIG. 1 is a diagram illustrating a configuration of a communication processing integrated circuit 1. The communication processing integrated circuit 1 includes a central processing unit (CPU) 10, an encryption processing device 20, a storage unit 60, a dynamic random access memory (DRAM) controller 30, a DRAM 2, and a communication processing device 40. In the communication processing integrated circuit 1, the CPU 10, the encryption processing device 20, the DRAM controller 30, the communication processing device 40, and the storage unit 60 are connected to a bus system 50 to perform data transfer with one another. This configuration is a typical configuration for an integrated circuit called system-on-a-chip. The CPU 10 controls the entire communication processing integrated circuit 1. The CPU 10 executes processing based on a program stored in the storage unit 60. The encryption processing device 20 encrypts data. The storage unit 60 stores programs and the like. The DRAM controller 30 controls data writing to the DRAM 2 and data reading from the DRAM 2. The communication processing device 40 connects the communication processing integrated circuit 1 to a local area network (LAN) 3. The communication processing integrated circuit 1 is an example of an information processing apparatus. An apparatus including the communication processing integrated circuit 1 is also an example of an information processing apparatus.

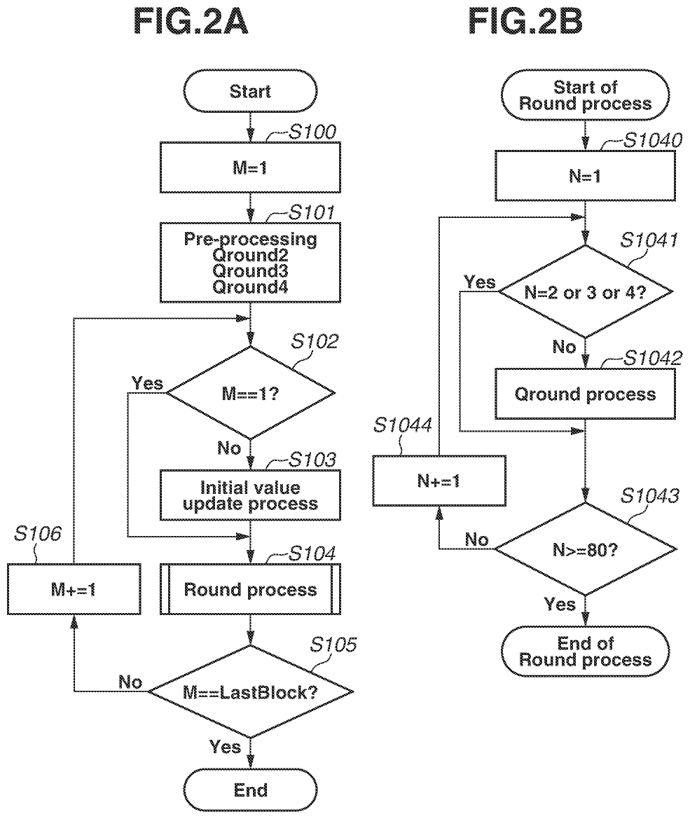

FIGS. 2A and 2B are flowcharts illustrating an example of an encryption process. The processing of the flowcharts in FIGS. 2A and 2B may be executed by the CPU 10 based on a program, or may be executed by hardware or the like in the encryption processing device 20.

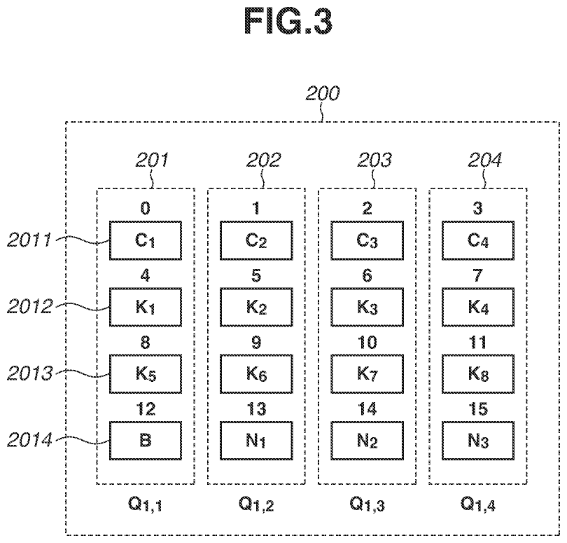

FIG. 3 is a diagram illustrating a plan of the storage unit 60 that stores data (hereinafter, such a piece of data being referred to as a state) used in operations. A state 200 is composed of 16 states in total, each of which is a 32-bit state (for example, 2011 and 2012). According to Nir, Y. and A. Langley, “ChaCha20 and Poly1305 for IETF Protocols”, RFC 7539, each state has fixed value: Cn, key: Kn, block count: B, nonce: Nn, as initial values, which are defined so that they are arranged as represented in FIG. 3. Four groups of states are defined as state groups 201, 202, 203, and 204. For example, the state group 201 includes states 2011, 2012, 2013, and 2014. For details, refer to Nir, Y. and A. Langley, “ChaCha20 and Poly1305 for IETF Protocols”, RFC 7539.

Each state group is used as an input and an output of a Qround process described below. For example, the state group 201 is used in Qround 1 and the state group 202 is used in Qround 2. For Qrounds 5 to 8, the definition of the state group is different, which is defined that they are combined in an oblique direction. A Round process is defined by a sub-function called Qround, and it is defined that the Qround process is performed 80 times for an input block of 64 bytes. For details of the Qround process, refer to Nir, Y. and A. Langley, “ChaCha20 and Poly1305 for IETF Protocols”, RFC 7539. Hereinafter, a target block to be operated is referred to as block M, and a Qround process in the Nth round is referred to as Qround N. Here, the specifications define that the initial value of the state 200 depending on the input block M is only block count: B (state 2014), and the other parameters are not changed. Paying attention to this, the state 2014 belongs to the state group 201 as described above, and accordingly, the Qround 1 process can be changed depending on the block M. However, the state group 202 to the state group 204 do not depend on the block M and the same parameters are used. Accordingly, it can be seen that the operation results of Qround 2 to Qround 4 are the same. In the present exemplary embodiment, taking into consideration such features, the following processing is defined to reduce process steps.

The state may be stored in the storage unit 60 illustrated in FIG. 1 or may exist in the internal register of the CPU 10. Further, when the encryption processing device 20 executes operations, the state may be in the internal memory of the encryption processing device 20, and the location where a storage device for storing the state is arranged is not limited.

The processing will be described below with reference to FIGS. 2A and 2B by way of example when the processing is executed by the CPU 10. The same applies to the following flowcharts.

In the Qround process, four sub-states are used as inputs for operations. The specifications of Qround 1 define that the Qround process is performed 80 times on the state group 201 (state 2011, state 2012, state 2013, state 2014) when input, and the states are updated with each data on which the operations have been performed. In the processes for N=1 to 4, it is defined that an input of an initial value is received and the initial value is changed according to the number of input blocks. However, only the state 2014 depends on the number M of input blocks. Accordingly, in the processes for N=2, 3, and 4, even when the block M changes, the initial values for the state group 202, the state group 203, and the state group 204 do not change. In view of this point, the following processing is defined in the present exemplary embodiment.

FIG. 2A is a flowchart illustrating an example of an encryption process according to the first exemplary embodiment. In step S100, the CPU 10 sets M=1. In step S101, the CPU 10 executes the processes of Qround 2, Qround 3, and Qround 4 as pre-processing, and stores the calculation results in the state groups 202, 203, and 204, respectively. If the state 200 is directly updated and used in the operations, the results calculated in step S101 as the pre-processing would be overwritten. In this regard, in step S102, the CPU 10 determines whether the target block to be operated is the first block (M=1) or the other blocks. In the CPU 10, if the target block to be operated is the first block, the processing proceeds to step S104, and if the target block to be operated is not the first block, the processing proceeds to step S103.

In step S103, the CPU 10 updates the initial values. The process of step S103 is a process, in a case where a method in which direct updating is implemented, of restoring the state groups 202, 203, and 204 to values obtained after the pre-processing in step S101 is performed on the block 1 when the respective processes for the block M+1 and subsequent blocks are performed. While the processing illustrated in FIG. 2A includes a branch, the branch is not essential, and the CPU 10 may execute the process of step S103 for the block of M=1. Further, in the case where a plurality of states 200 is prepared for respective different areas, the process of step S103 is not necessary. In step S104, the CPU 10 executes a Round process for each input block M using the updated state 200. Details of the Round process in step S104 are presented in FIG. 2B described below. In step S105, the CPU 10 determines whether the block M is the last block, after executing the Round process. In the CPU 10, if the block M is the last block, the information processing ends, and if the block M is not the last block, the processing proceeds to step S106. In step S106, the CPU 10 increments M by 1. The CPU 10 then executes the processes from step S102. Qround 2, Qround 3, and Qround 4 are examples of specific rounds. Further, the processes from steps S102 to step S105 or step S106 are an example of block processing. Further, the timing of step S103 is an example of the start of block processing. Qround 2 is an example of the second round. Qround 3 is an example of the third round. Qround 4 is an example of the fourth round.

FIG. 2B is a flowchart illustrating details of the Round process in step S104. In step S1040, the CPU 10 sets N=1. In step S1041, the CPU 10 checks the value of N to determine whether the pre-processing in step S101 has been executed. If the pre-processing has been executed, the Qround process is not executed. The Qround process is executed for the remaining N. Specifically, the CPU 10 determines whether N is 2, 3, or 4. In the CPU 10, if N is 2, 3, or 4, the processing proceeds to step S1043, and if N is not 2, 3, or 4, the processing proceeds to step S1042. In step S1042, the CPU 10 executes the Qround process. In step S1043, the CPU 10 determines whether the corresponding round is the last. In other words, the CPU 10 determines whether N is 80 or more. In the CPU 10, if N is 80 or more, the Round process ends, and if N is not 80 or more, the processing proceeds to step S1044. In step S1044, the CPU 10 increments N by 1. The CPU 10 then repeats the processes from step S1041.

In the ChaCha algorithm, Qround is executed for 80 rounds, and post-processing is executed for the input block M, which is data to be processed, using the calculated state 200. The description for the post-processing is omitted for simplification purposes.

With the communication processing integrated circuit 1 of the first exemplary embodiment, it is possible to reduce process steps and further reduce power consumption.

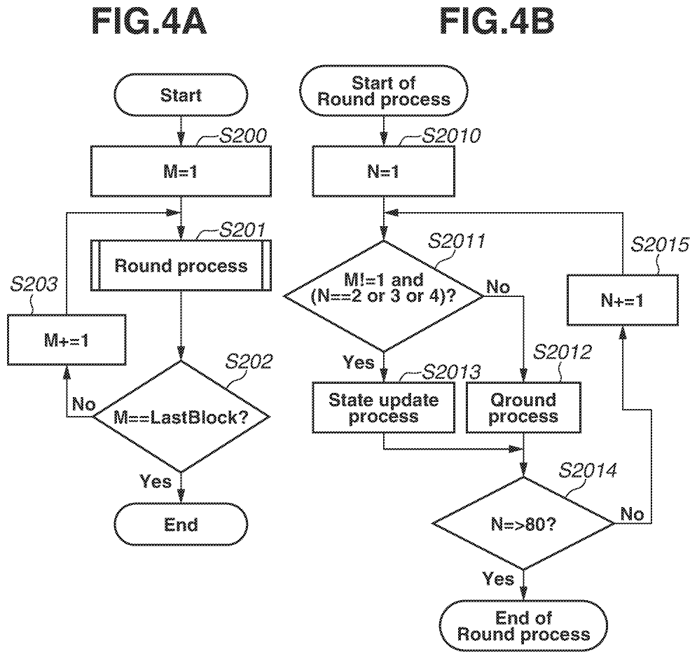

A second exemplary embodiment will now be described. In the second exemplary embodiment, differences from the first exemplary embodiment will be mainly described. FIG. 4A is a flowchart illustrating an example of information processing according to the second exemplary embodiment. Unlike the processing of the first exemplary embodiment, the processing of the second exemplary embodiment is processing in which the Qround process for the first input block (M=1) is executed, but the Qround processes for the second and subsequent input blocks (M=2 and more) are reduced, and accordingly process steps are reduced.

In step S200, the CPU 10 sets M=1 for each input block M. In step S201, the CPU 10 executes a Round process. Details of the Round process in step S201 are presented in FIG. 4B described below. In step S202, the CPU 10 determines whether the block M is the last block, after executing the Round process. In the CPU 10, if the block M is the last block, the information processing ends, and if the block M is not the last block, the processing proceeds to step S203. In step S203, the CPU 10 increments M by 1. The CPU 10 then executes the processes from step S201.

FIG. 4B is a flowchart illustrating details of the Round process in Step S201.

In step S2010, the CPU 10 sets an initial value as N=1. In step S2011, the CPU 10 determines whether M is not 1 and N is 2, 3, or 4. In the CPU 10, if M is not 1 and N is 2, 3 or 4, the processing proceeds to step S2013, and otherwise, the processing proceeds to step S2012. In step S2012, the CPU 10 performs a Qround process. The CPU 10 holds the calculation results of the Qround process in the storage unit 60, for example. If M is 1 or if M is not 1 and N is any one of 1, 5 to 80, the Qround process in step S2012 is executed. For the remaining blocks (M!=1), the Qround (N=2, 3, 4) may be eliminated. In step S2013, the CPU 10 acquires the state calculated for the block (M=1) from the storage unit 60, and updates the target state to be operated. In step S2014, the CPU 10 determines whether the corresponding round is the last. In other words, the CPU 10 determines whether N is 80 or more. In the CPU 10, if N is 80 or more, the Round process ends, and if N is not 80 or more, the processing proceeds to step S2015. In step S2015, the CPU 10 increments N by 1. The CPU 10 then repeats the processes from step S2011.

In the ChaCha algorithm, Qround is executed for 80 rounds, and post-processing is executed for the input block M, which is data to be processed, using the calculated state 200. The description for the post-processing is omitted for simplification purposes.

With the communication processing integrated circuit 1 of the second exemplary embodiment, it is possible to reduce process steps and further reduce power consumption.

A third exemplary embodiment will now be described. In the third exemplary embodiment, differences from the above-described exemplary embodiments will be mainly described.

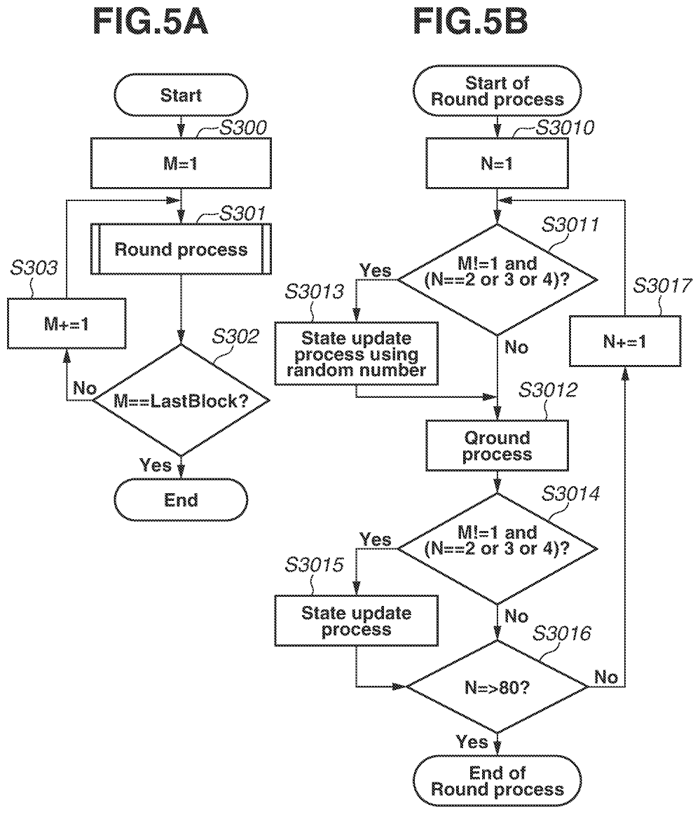

FIG. 5A is a flowchart illustrating an example of information processing according to the third exemplary embodiment. The processes of steps S300 to S303 are the same as the processes of steps S200 to S202 in FIG. 4A of the second exemplary embodiment, and accordingly, the description of these processes is not repeated.

FIG. 5B is a flowchart illustrating details of the Round process in Step S301.

In step S3010, the CPU 10 assigns an initial value of N=1. In step S3011, the CPU 10 determines whether M is not 1 and N is 2, 3, or 4. In the CPU 10, if M is not 1 and N is 2, 3 or 4, the processing proceeds to step S3013, and otherwise, the processing proceeds to step S3012. In step S3012, the CPU 10 executes the Qround process using the set initial state. In step S3013, the CPU 10 updates the corresponding state using a random number or the like. Subsequently to step S3013, the processing proceeds to step S3012, and the CPU 10 executes the Qround process using the state updated using the random number or the like. When the processing proceeds from step S3013 to step S3012, in which the Qround process is executed, the calculation result of the Qround process is not used. Accordingly, the CPU 10 may discard the calculation results or may temporarily store the calculation results in the storage unit 60 or the like.

In step S3014, the CPU 10 determines whether M is not 1 and N is 2, 3 or 4. In the CPU 10, if M is not 1 and N is 2, 3 or 4, the processing proceeds to step S3015, and otherwise, the processing proceeds to step S3016. In step S3015, since, in the corresponding round, the operation has been performed by using a random number and the like, the CPU 10 executes a state update process to restore the state to a correct value. More specifically, the CPU 10 acquires the state calculated in the previous block (M=1) from the storage unit 60, and updates the target state to be operated with the acquired state. In the example of the present exemplary embodiment, the corresponding state is updated using a random number or the like in step S3013, but the CPU 10 may substitute a prepared value or the like into the state, for example, at the timing before the execution of step S300 in FIG. 5A. The process of step S3015 is an example of a process of writing a calculated value in the state. In step S3016, the CPU 10 determines whether the corresponding round is the last. In other words, the CPU 10 determines whether N is 80 or more. In the CPU 10, if N is 80 or more, the Round process ends, and if N is not 80 or more, the processing proceeds to step S3017. In step S3017, the CPU 10 increments N by 1. The CPU 10 then repeats the processes from step S3011.

In the ChaCha algorithm, Qround is executed for 80 rounds, and post-processing is executed for the input block M, which is data to be processed, using the calculated state 200. The description for the post-processing is omitted for simplification purposes.

According to the communication processing integrated circuit 1 of the third exemplary embodiment, it is possible to improve the side channel tolerance by using a random number or the like to cause disturbance. The random number is an example of a value having no regularity, and any other value that can withstand a side channel attack may be used.

While examples of exemplary embodiments of the present disclosure have been described in detail above, the present disclosure is not limited to such specific exemplary embodiments.

In the respective exemplary embodiments described above, the encryption process has been described as an example. However, if a decryption processing device is provided in the communication processing integrated circuit 1, the same processing can be executed for a decryption process to achieve the above-described advantageous effects.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-018697, filed Feb. 5, 2019, which is hereby incorporated by reference herein in its entirety.

What is claimed is:

1. An information processing apparatus that executes a Round process for respective blocks related to the ChaCha algorithm, the information processing apparatus comprising:
a control unit configured to execute a Qround process in the Round process; and
a holding unit configured to hold at least a part of results of the execution of the Qround process,
wherein the control unit is configured to, in a case where a target round to be operated is a specific round, skip the execution of the Qround process of the target round by using at least the part of results of the execution of the Qround process held by the holding unit.

2. The information processing apparatus according to claim 1, wherein the control unit is configured to execute a process for the specific round in pre-processing prior to block processing, and update, at the start of the block processing, a specific initial value to a value obtained as a result of the process for the specific round executed in the pre-processing.

3. The information processing apparatus according to claim 2, wherein the control unit is configured to skip, in a case where a target block to be operated is a first block, a process of updating the specific initial value to the value obtained as the result of the process for the specific round executed in the pre-processing.

4. The information processing apparatus according to claim 1, wherein the specific rounds are a second Qround, a third Qround, and a fourth Qround.

5. The information processing apparatus according to claim 1, wherein the control unit is configured to execute a state update process in a case where the target round to be operated is the specific round.

6. The information processing apparatus according to claim 5, wherein the specific rounds are a second Qround, a third Qround, and a fourth Qround for a block that is not a first block.

7. The information processing apparatus according to claim 1, wherein the control unit is configured to write a predetermined value in a state and then write a calculated value in the state in a case where the target round to be operated is the specific round.

8. The information processing apparatus according to claim 7, wherein the predetermined value is a random number.

9. The information processing apparatus according to claim 7, wherein the specific rounds are a second Qround, a third Qround, and a fourth Qround for a block that is not a first block.

10. An information processing method of executing a Round process for respective blocks related to the ChaCha algorithm, the information processing method comprising:
performing a control for executing a Qround process in the Round process; and
holding at least a part of results of the execution of the Qround process,
wherein the control includes skipping, in a case where a target round to be operated is a specific round, the execution of the Qround process of the target round by using at least the part of results of the execution of the Qround process held by the holding.

11. The information processing method according to claim 10, wherein the control includes executing a process for the specific round in pre-processing prior to block processing, and updating, at the start of the block processing, a specific initial value to a value obtained as a result of the process for the specific round executed in the pre-processing.

12. The information processing method according to claim 11, wherein the control includes skipping, in a case where a target block to be operated is a first block, a process of updating the specific initial value to the value obtained as the result of the process for the specific round executed in the pre-processing.

13. The information processing method according to claim 10, wherein the specific rounds are a second Qround, a third Qround, and a fourth Qround.

14. The information processing method according to claim 10, wherein the control includes executing a state update process in a case where the target round to be operated is the specific round.

15. The information processing method according to claim 14, wherein the specific rounds are a second Qround, a third Qround, and a fourth Qround for a block that is not a first block.

16. The information processing method according to claim 10, wherein the control includes writing a predetermined value in a state and then writing a calculated value in the state in case where the target round to be operated is the specific round.

17. The information processing method according to claim 16, wherein the predetermined value is a random number.

18. The information processing method according to claim 16, wherein the specific rounds are a second Qround, a third Qround, and a fourth Qround for a block that is not a first block.

19. A non-transitory storage medium storing a program causing a computer to execute an information processing method of executing a Round process for respective blocks related to the ChaCha algorithm, the method comprising:
performing a control of executing a Qround process in the Round process; and
holding at least a part of results of the execution of the Qround process,
wherein the control includes skipping, in a case where a target round to be operated is a specific round, the execution of the Qround process of the target round by using at least the part of results of the execution of the Qround process held at the holding.

20. The non-transitory storage medium according to claim 19, wherein the control includes executing a process for the specific round in pre-processing prior to block processing, and updating, at the start of the block processing, a specific initial value to a value obtained as a result of the process for the specific round executed in the pre-processing.
